(19) United States
(12) Patent Application Publication
(10) Pub. No.: US 2021/0384979 A1
(43) Pub. Date: Dec. 9, 2021

(54) INFORMATION COMMUNICATION USING EQUIPMENT INDICATOR LIGHTS

(71) Applicant: Telefonaktiebolaget LM Ericsson (publ), Stockholm (SE)

(72) Inventor: Stefan DAHLFORT, STOCKHOLM (SE)

(73) Assignee: Telefonaktiebolaget LM Ericsson (publ), Stockholm (SE)

(21) Appl. No.: 16/892,022

(22) Filed: Jun. 3, 2020

(51) Int. Cl. H04B 10/50; H04B 10/116; H04B 10/524; H04B 10/61; H04L 12/24

(52) U.S. Cl. CPC H04B 10/502; H04B 10/116; H04L 41/0686; H04B 10/616; H04B 10/524

(57) ABSTRACT

A method by a mobile device for conveying information communicated via a plurality of discrete indicator lights of an electronic device. The method includes capturing, via an image capturing component of the mobile device, a light pattern emitted by the plurality of discrete indicator lights of the electronic device, where the light pattern communicates information related to the electronic device according to a pre-defined light pattern scheme, interpreting the light pattern in accordance with the pre-defined light pattern scheme to determine the information communicated by the light pattern, and conveying the information communicated by the light pattern to an end user.

### TECHNICAL FIELD

Embodiments of the invention relate to the field of electronic devices, and more specifically, to communicating information via indicator lights of electronic devices.

### BACKGROUND

Communication service providers deploy many network devices around the world to provide communication services to customers. These network devices may include, for example, devices for implementing radio access networks (RANs), transport networks, and data centers. A physical network device has a life cycle that includes deployment, runtime, and decommission phases, where each phase typically requires manual steps to be taken by an on-site technician. For some of the manual steps, it is beneficial if the physical network device can communicate information to the technician such as the details of a fault, what upgrades are needed, and how to install those upgrades.

Communication service providers and network owners are pressed to improve profitability, and consequently there is pressure on network device manufacturers/providers to reduce the cost of deploying, operating, and maintaining its products. A physical network device typically includes a set of light emitting diode (LED) indicators for indicating the status of the network device. The number of LED indicators that can be included on a physical network device is typically limited due to cost and/or space limitations. As such, each LED is often used to potentially indicate many different information states, which can make interpreting the meaning of a LED indicator more difficult. The network device manufacturer/provider typically provides a manual that describes the meaning of the different LED indicators. While the network device manufacturer/provider may strive to make the manual as easy to understand as possible, it can still be difficult for the technician to process the information, especially in a stressed situation on-site. It easily happens that the technician has difficulty finding the correct manual, has problems locating the relevant information in the manual, or misreads/misunderstands the information provided in the manual. This may result in longer repair times and/or incorrect/incomplete repairs, which may in turn result in prolonged network outages.

### SUMMARY

A method by an electronic device to communicate information related to the electronic device. The method includes emitting, using a plurality discrete indicator lights of the electronic device, a first light pattern that communicates first information related to the electronic device according to a first pre-defined light pattern scheme, where the first light pattern is to be interpreted directly by a human observing the first light pattern, emitting, using the plurality discrete indicator lights of the electronic device, a second light pattern that communicates second information related to the electronic device according to a second pre-defined light pattern scheme, where the second light pattern is to be interpreted by a mobile device capturing the second light pattern via an image capturing component of the mobile device as opposed to being interpreted directly by a human, and alternating between emitting the first light pattern and the second light pattern.

A set of one or more non-transitory machine-readable storage media storing instructions which, when executed by one or more processors of an electronic device, causes the electronic device to perform operations for communicating information related to the electronic device. The operations include emitting, using a plurality discrete indicator lights of the electronic device, a first light pattern that communicates first information related to the electronic device according to a first pre-defined light pattern scheme, where the first light pattern is to be interpreted directly by a human observing the first light pattern, emitting, using the plurality discrete indicator lights of the electronic device, a second light pattern that communicates second information related to the electronic device according to a second pre-defined light pattern scheme, where the second light pattern is to be interpreted by a mobile device capturing the second light pattern via an image capturing component of the mobile device as opposed to being interpreted directly by a human, and alternating between emitting the first light pattern and the second light pattern.

An electronic device configured to communicate information related to the electronic device. The electronic device includes one or more processors and a non-transitory machine-readable storage medium having instructions stored therein, which when executed by the one or more processors, causes the electronic device to emit, using a plurality discrete indicator lights of the electronic device, a first light pattern that communicates first information related to the electronic device according to a first pre-defined light pattern scheme, where the first light pattern is to be interpreted directly by a human observing the first light pattern, emit, using the plurality discrete indicator lights of the electronic device, a second light pattern that communicates second information related to the electronic device according to a second pre-defined light pattern scheme, where the second light pattern is to be interpreted by a mobile device capturing the second light pattern via an image capturing component of the mobile device as opposed to being interpreted directly by a human, and alternate between emitting the first light pattern and the second light pattern.

A method by a mobile device for conveying information communicated via a plurality of discrete indicator lights of an electronic device. The method includes capturing, via an image capturing component of the mobile device, a light pattern emitted by the plurality of discrete indicator lights of the electronic device, where the light pattern communicates information related to the electronic device according to a pre-defined light pattern scheme, interpreting the light pattern in accordance with the pre-defined light pattern scheme to determine the information communicated by the light pattern, and conveying the information communicated by the light pattern to an end user.

A set of one or more non-transitory machine-readable storage media storing instructions which, when executed by one or more processors of a mobile device, causes the mobile device to perform operations for conveying information communicated via a plurality of discrete indicator lights of an electronic device. The operations include capturing, via an image capturing component of the mobile device, a light pattern emitted by the plurality of discrete indicator lights of the electronic device, where the light pattern communicates information related to the electronic device according to a pre-defined light pattern scheme, interpreting the light pattern in accordance with the pre-defined light pattern scheme to determine the information communicated by the light pattern, and conveying the information communicated by the light pattern to an end user.

A mobile device configured to convey information communicated via a plurality of discrete indicator lights of an electronic device. The mobile device includes one or more processors and a non-transitory machine-readable storage medium having instructions stored therein, which when executed by the one or more processors, causes the mobile device to capture, via an image capturing component of the mobile device, a light pattern emitted by the plurality of discrete indicator lights of the electronic device, where the light pattern communicates information related to the electronic device according to a pre-defined light pattern scheme, interpret the light pattern in accordance with the pre-defined light pattern scheme to determine the information communicated by the light pattern, and convey the information communicated by the light pattern to an end user.

### BRIEF DESCRIPTION OF THE DRAWINGS

The invention may best be understood by referring to the following description and accompanying drawings that are used to illustrate embodiments of the invention. In the drawings:

FIG. 1 is a block diagram illustrating an electronic device that can emit light patterns and a mobile device that can interpret light patterns emitted by the electronic device, according to some embodiments.

FIG. 2 is a diagram illustrating a light pattern table, according to some embodiments.

FIG. 3A is a diagram illustrating a light pattern emitted according to a conventional/legacy light pattern scheme, according to some embodiments.

FIG. 3B is a diagram illustrating a light pattern emitted according to the new light pattern scheme, according to some embodiments.

FIG. 4 is a flow diagram of a process for interpreting light patterns emitted by an electronic device, according to some embodiments.

FIG. 5 is a flow diagram of a process for communicating information using a plurality of discrete indicator lights, according to some embodiments.

FIG. 6 is a block diagram illustrating an electronic device, according to some embodiments.

FIG. 7A illustrates connectivity between network devices (NDs) within an exemplary network, as well as three exemplary implementations of the NDs, according to some embodiments.

FIG. 7B illustrates an exemplary way to implement a special-purpose network device according to some embodiments.

### DETAILED DESCRIPTION

The following description describes methods and apparatus for communicating information via indicator lights of an electronic device. In the following description, numerous specific details such as logic implementations, opcodes, means to specify operands, resource partitioning/sharing/duplication implementations, types and interrelationships of system components, and logic partitioning/integration choices are set forth in order to provide a more thorough understanding of the present invention. It will be appreciated, however, by one skilled in the art that the invention may be practiced without such specific details. In other instances, control structures, gate level circuits and full software instruction sequences have not been shown in detail in order not to obscure the invention. Those of ordinary skill in the art, with the included descriptions, will be able to implement appropriate functionality without undue experimentation.

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

Bracketed text and blocks with dashed borders (e.g., large dashes, small dashes, dot-dash, and dots) may be used herein to illustrate optional operations that add additional features to embodiments of the invention. However, such notation should not be taken to mean that these are the only options or optional operations, and/or that blocks with solid borders are not optional in certain embodiments of the invention.

In the following description and claims, the terms “coupled” and “connected,” along with their derivatives, may be used. It should be understood that these terms are not intended as synonyms for each other. “Coupled” is used to indicate that two or more elements, which may or may not be in direct physical or electrical contact with each other, co-operate or interact with each other. “Connected” is used to indicate the establishment of communication between two or more elements that are coupled with each other.

An electronic device stores and transmits (internally and/or with other electronic devices over a network) code (which is composed of software instructions and which is sometimes referred to as computer program code or a computer program) and/or data using machine-readable media (also called computer-readable media), such as machine-readable storage media (e.g., magnetic disks, optical disks, solid state drives, read only memory (ROM), flash memory devices, phase change memory) and machine-readable transmission media (also called a carrier) (e.g., electrical, optical, radio, acoustical or other form of propagated signals—such as carrier waves, infrared signals). Thus, an electronic device (e.g., a computer) includes hardware and software, such as a set of one or more processors (e.g., wherein a processor is a microprocessor, controller, microcontroller, central processing unit, digital signal processor, application specific integrated circuit, field programmable gate array, other electronic circuitry, a combination of one or more of the preceding) coupled to one or more machine-readable storage media to store code for execution on the set of processors and/or to store data. For instance, an electronic device may include non-volatile memory containing the code since the non-volatile memory can persist code/data even when the electronic device is turned off (when power is removed), and while the electronic device is turned on that part of the code that is to be executed by the processor(s) of that electronic device is typically copied from the slower non-volatile memory into volatile memory (e.g., dynamic random access memory (DRAM), static random access memory (SRAM)) of that electronic device. Typical electronic devices also include a set of one or more physical network interface(s) (NI(s)) to establish network connections (to transmit and/or receive code and/or data using propagating signals) with other electronic devices. For example, the set of physical NIs (or the set of physical NI(s) in combination with the set of processors executing code) may perform any formatting, coding, or translating to allow the electronic device to send and receive data whether over a wired and/or a wireless connection. In some embodiments, a physical NI may comprise radio circuitry capable of receiving data from other electronic devices over a wireless connection and/or sending data out to other devices via a wireless connection. This radio circuitry may include transmitter(s), receiver(s), and/or transceiver(s) suitable for radiofrequency communication. The radio circuitry may convert digital data into a radio signal having the appropriate parameters (e.g., frequency, timing, channel, bandwidth, etc.). The radio signal may then be transmitted via antennas to the appropriate recipient(s). In some embodiments, the set of physical NI(s) may comprise network interface controller(s) (NICs), also known as a network interface card, network adapter, or local area network (LAN) adapter. The NIC(s) may facilitate in connecting the electronic device to other electronic devices allowing them to communicate via wire through plugging in a cable to a physical port connected to a NIC. One or more parts of an embodiment of the invention may be implemented using different combinations of software, firmware, and/or hardware.

A network device (ND) is an electronic device that communicatively interconnects other electronic devices on the network (e.g., other network devices, end-user devices). Some network devices are “multiple services network devices” that provide support for multiple networking functions (e.g., routing, bridging, switching, Layer 2 aggregation, session border control, Quality of Service, and/or subscriber management), and/or provide support for multiple application services (e.g., data, voice, and video).

As mentioned above, a physical network device typically includes a set of light emitting diode (LED) indicators for indicating the status of the network device. The number of LED indicators that can be included on a physical network device is typically limited due to cost and/or space limitations. As such, each LED is often used to potentially indicate many different information states, which can make interpreting the meaning of a LED indicator more difficult. The network device manufacturer/provider typically provides a manual that describes the meaning of the different LED indicators. While the network device manufacturer/provider may strive to make the manual as easy to understand as possible, it can still be difficult for the technician to process the information, especially in a stressed situation on-site. It easily happens that the technician has difficulty finding the correct manual, has problems locating the relevant information in the manual, or misreads/misunderstands the information provided in the manual. This may result in longer repair times and/or incorrect/incomplete repairs, which may in turn result in prolonged network outages.

According to some embodiments, a mobile device is provided that can convey information communicated via the indicator lights of an electronic device (e.g., a network device). The mobile device may use an image capturing component of the mobile device (e.g., a camera integrated in the mobile device) to capture light patterns emitted by the indicator lights of an electronic device, interpret the light patterns to determine the meaning of the light patterns, and convey the meaning of the light patterns to an end user of the mobile device (e.g., using a display screen of the mobile device). An on-site technician may simply use the mobile device to take a picture or video (e.g., if the light pattern involves flashing lights) of light patterns emitted by the electronic device and the mobile device will convey the meaning of those light patterns to the technician. This allows the technician to more quickly and accurate determine the meaning of light patterns emitted by the electronic device compared to having to manually search for the meaning in a manual.

According to some embodiments, an electronic device is provided that can communicate textual information using its indicator lights. For example, the electronic device may emit light patterns according to a new light pattern scheme that uses a modulation technique such as on/off keying modulation, amplitude modulation, and/or pulse position modulation. For example, with an on/off keying modulation technique, each indicator light may represent a binary value during a frame period, where the binary value is ‘0’ if the indicator light is in the “off” state and the binary value is ‘1’ if the indicator light is in an “on” state. Textual information may be encoded using an American Standard Code for Information Interchange (ASCII) text encoding format or similar text encoding format. Since light patterns emitted according to the pre-new light pattern scheme may be difficult if not impossible for the human eye/brain to follow/process, a mobile device may be provided that can capture the light patterns (e.g., as a video using a camera integrated within the mobile device), interpret the light patterns in accordance with the new light pattern scheme to determine the textual information communicated by the light patterns, and convey the textual information communicated by the light patterns to an end user. This allows the electronic device to communicate more detailed/rich information compared to the conventional/legacy use of the indicator lights. For example, the indicator lights may be used to communicate textual instructions on how to resolve a problem with the electronic device, more detailed status information related to the electronic device, and/or a uniform resource locator (URL) associated with a web page that includes further information related to the electronic device.

According to some embodiments, the electronic device may alternate between emitting light patterns according to the conventional/legacy light pattern scheme (e.g., a light pattern scheme where each indicator light indicates certain information, as described in the manual for the electronic device) and emitting light patterns according to the new light pattern scheme (e.g., the light pattern scheme that can be used to communicate textual information). For example, the electronic device may alternate between emitting light patterns according to the conventional/legacy light pattern scheme and emitting light patterns according to the new light pattern scheme every 15 seconds. This may allow a technician that has a mobile device capable of interpreting light patterns using the new light pattern scheme to take advantage of the enhanced functionality/information provided by the new light pattern scheme while still allowing a technician that does not have such a mobile device to be able to determine information related to the electronic device based on the conventional/legacy light pattern scheme (e.g., based on the technician observing the conventional/legacy light patterns with his/her eyes). Embodiments are further described herein below with reference to the accompanying figures.

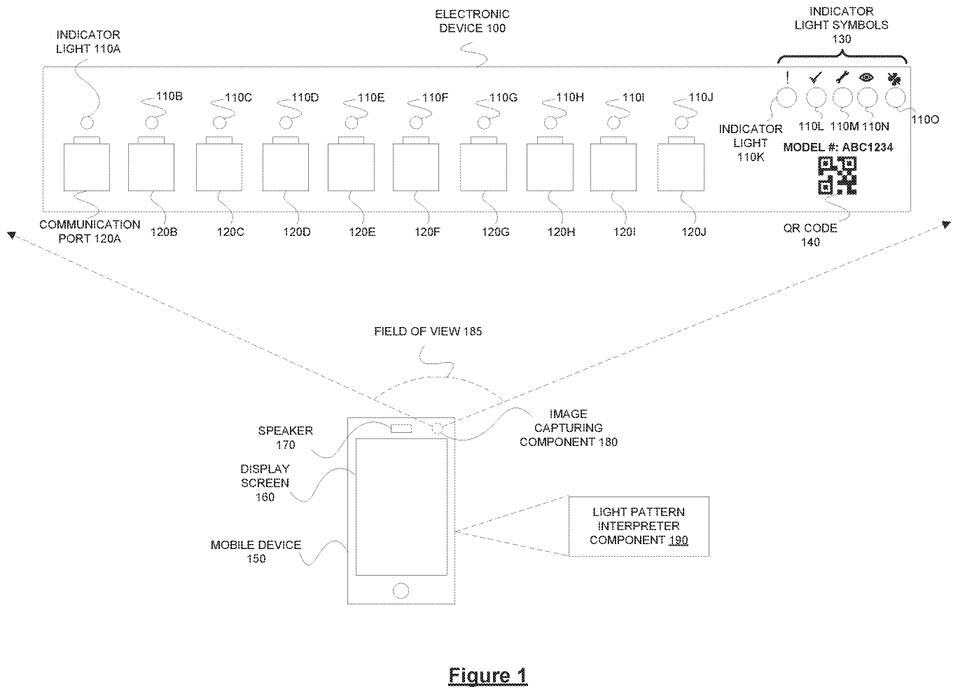

FIG. 1 is a block diagram illustrating an electronic device that can communicate information via its indicator lights and a mobile device that can interpret light patterns emitted by the indicator lights of the electronic device, according to some embodiments. As shown in the diagram, the electronic device 100 includes multiple communication ports 120A-J and corresponding indicator lights 110A-J. Each of the indicator lights 110A-J may be used to indicate the status of the corresponding communication port 120. For example, indicator light 110A may be used to indicate the status of communication port 120A, indicator light 110B may be used to indicate the status of communication port 120B, and so forth. According to conventional/legacy usage, an indicator light 110 being in an “on” state may indicate that the corresponding communication port 120 is active (e.g., being used to transmit/receive data) whereas an indicator light 110 being in an “off” state may indicate that the corresponding communication port 120 is inactive (e.g., not being used to transmit/receive data). In one embodiment, one or more of the communication ports 120 are Ethernet ports that accept cables having RJ-45 connectors. In one embodiment, each of the indicator lights 110A-J are monochromatic light emitting diode (LED) indicator lights.

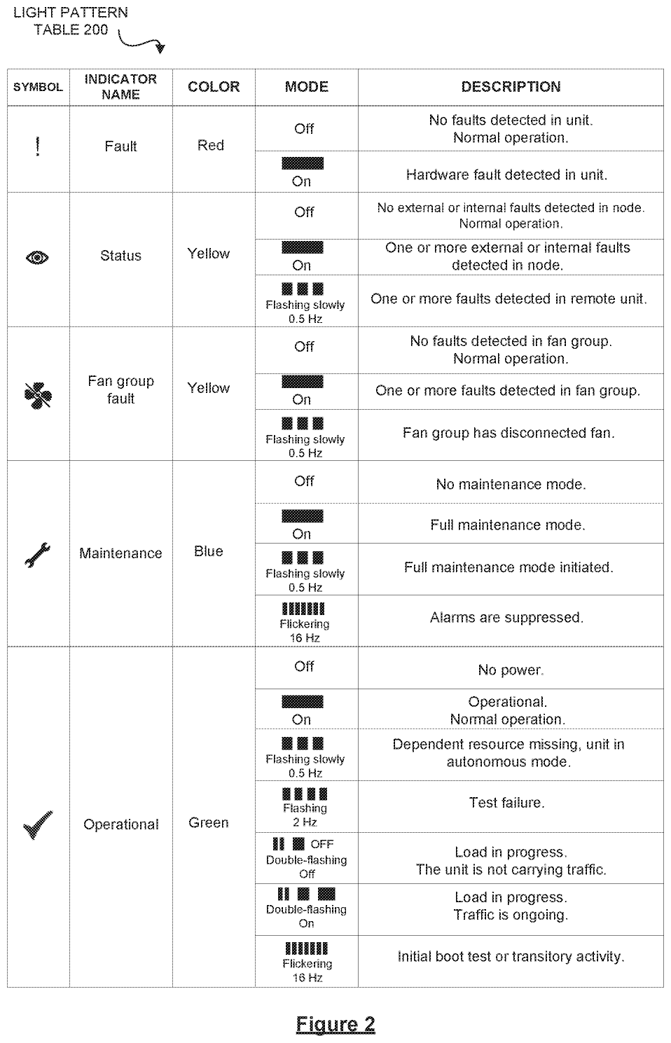

Also, as shown in the diagram, the electronic device 100 includes indicator lights 110K-O that are each labeled with indicator light symbols 130. For example, indicator light 110K is labeled with an exclamation mark symbol, indicator light 110L is labeled with a check mark symbol, indicator light 110M is labeled with a wrench symbol, indicator light 110N is labeled with an eye symbol, and indicator light 110O is labeled with a fan with strikethrough symbol. In one embodiment, each of the indicator lights 110K-O are monochromatic LED indicator lights. According to conventional/legacy usage, each of the indicator lights 110K-O may be used to indicate certain information related to the electronic device 100. For example, indicator light 110K (labeled with an exclamation mark symbol) may be used to indicate information related to faults detected in the electronic device 100, indicator light 110L (labeled with a check mark symbol) may be used to indicate information related to an operational status of the electronic device 100, indicator light 110M (labeled with a wrench symbol) may be used to indicate information related to the maintenance mode of the electronic device 100, indicator light 110N (labeled with an eye symbol) may be used to indicate information related to a status of the electronic device 100, and indicator light 110O (labeled with fan with strikethrough symbol) may be used to indicate information related to a fan group fault in the electronic device 100. For example, the indicator lights 110K-O may be used to indicate information according to the light pattern scheme described by the light pattern table 200 shown in FIG. 2. Each of the indicator lights 100 may be “discrete” indicator lights in the sense that they are stand-alone indicator lights (and not lights that form part of a display screen).

According to the light pattern table 200, indicator light 110K (labeled with an exclamation mark symbol) is a red in color and can be in “off” state or an “on” state, with each state representing certain information as indicated in the corresponding entry in the “description” column. Indicator light 110N (labeled with an eye symbol) is yellow in color and can be in an “off” state, an “on” state, and a “flashing slowly” state (flashing at a rate of 0.5 Hertz), with each state representing certain information as indicated in the corresponding entry in the “description” column. Indicator light 110O (labeled with a fan with strikethrough symbol) is yellow in color and can be in an “off” state, an “on” state, and a “flashing slowly” state (flashing at a rate of 0.5 Hertz), with each state representing certain information as indicated in the corresponding entry in the “description” column. Indicator light 110M (labeled with a wrench symbol) is blue in color and can be in an “off” state, an “on” state, a “flashing slowly” state (flashing at a rate of 0.5 Hertz), and a “flickering” state (flashing at a rate of 16 Hertz), with each state representing certain information as indicated in the corresponding entry in the “description” column. Indicator light 110L is green in color and can be in an “off” state, an “on” state, a “flashing slowly” state (flashing at a rate of 0.5 Hertz), a “flashing” state (flashing at a rate of 2 Hertz), a “double-flashing off” state, a “double-flashing on” state, and a “flickering” state (flashing at a rate of 16 Hertz), with each state representing certain information as indicated in the corresponding entry in the “description” column. The light pattern table 200 thus describes a conventional/legacy light pattern scheme that maps different pre-defined light patterns to different pre-defined information (e.g., the information in the “description” column). In this example, the conventional/legacy light pattern scheme allows for 19 different states and thus is limited to providing 19 different types of pre-defined information (e.g., the 19 rows in the “description” column of the light pattern table 200). The conventional/legacy light pattern is used primarily for emitting light patterns that are intended to be observed and interpreted by a human (without the assistance of a mobile device 150). While a particular light pattern scheme is described by the light pattern table 200 it should be understood that this light pattern scheme is provided by way of example and is not intended to be limiting. Other embodiments may use different light pattern schemes than described by the light pattern table 200.

In one embodiment, the electronic device 100 uses the indicator lights 110 to communicate textual information. The electronic device 100 may achieve this by emitting light patterns according to a new light pattern scheme (in addition to or alternatively to emitting light patterns according to the conventional/legacy light pattern scheme). A mobile device 150 may be provided that can capture the light patterns emitted by the electronic device 100 (e.g., using the image capturing component 180 of the mobile device 150 (e.g., a camera integrated within the mobile device 150), interpret the light patterns in accordance with the pre-defined light pattern scheme to determine the textual information communicated by the light patterns, and convey the textual information communicated by the light patterns to an end user. The new light pattern scheme may use a modulation technique such as on/off keying modulation to communicate information. With an on/off keying modulation technique, each indicator light 110 may be used to indicate a binary value during a frame period, where the binary value is ‘0’ if the indicator light 110 is in the “off” state and the binary value is ‘1’ if the indicator light 110 is in an “on” state. If there are five monochromatic indicator lights 110K-O being used for emitting light patterns, then five bits of information can be indicated during each frame period.

In one embodiment, modulation techniques other than the on/off keying modulation technique can be used such as an amplitude modulation technique, and/or pulse position modulation technique. For example, with a pulse amplitude modulation technique, each indicator light 110 may be used to indicate a value during a frame period, where the value depends on the intensity level of that indicator light 110. For example, the value may be ‘0’ if the indicator light is in an “off” state, the value may be ‘1’ if the indicator light is in a “half-on” (half intensity) state, and the value may be ‘2’ if the indicator light is in an “on” (full intensity) state. This can increase communication rate compared to using the on/off keying modulation technique by 50 percent (but may require training information to know which intensities correspond to half intensity and full intensity levels). With a pulse position modulation technique, each indicator light 110 may be used to indicate a value that depends on the frame of appearance of that indicator light 110.

Textual information may be encoded using an ASCII text encoding format (e.g., using 7 bits to represent a character) or other standardized text encoding format, or even a proprietary text encoding format. The new light pattern scheme may provide a format for communicating information as is done for typical communication channels. For example, the new light pattern scheme may provide a format that includes a frame start indicator to indicate the start of a frame, a frame end indicator to indicate the end of a frame, a frame length indicator to indicate the length of a frame, and/or error detection information (e.g., a hash value of the payload which the receiver can use to determine whether there were any errors introduced during transmission).

The length of each frame period may depend on the capability of the imaging device/component that is used to capture the light patterns (e.g., the image capturing component 180 of the mobile device 150). For example, if the imaging device/component is capable of capturing video at a frame rate of 30 frames per second, then the length of each frame period may be 1/30th of a second. This means that if there are five monochromatic indicator lights 110K-O being used for emitting light patterns, five bits of information can be communicated every 1/30th of a second, resulting in a communication rate of 150 bits per second. The communication rate can be increased by using more indicator lights 110, using multichromatic indicator lights (instead of monochromatic indicator lights), increasing the frame rate (e.g., by using a camera with a higher frame rate and/or capturing video using slow motion mode (e.g., some slow motion modes allow for capturing video at 240 frames per second or above), which allows for shortening the length of the frame periods), and/or using multiple image capturing devices (e.g., to process light patterns independently).

As shown in the diagram, the mobile device 150 includes a display screen 160, a speaker 170, an image capturing component 180, and a light pattern interpreter component 190. The mobile device 150 may be operated by an end user (e.g., a technician that is responsible for diagnosing, repairing, and/or configuring the electronic device 100). The end user of the mobile device 150 may use the mobile device 150 to capture an image or video of a light pattern emitted by the indicator lights 110 of the electronic device 100 (e.g., by pointing the image capturing component 180 of the mobile device 150 towards the electronic device 100 such that the applicable indicator lights 110 of the electronic device 100 are within the field of view 185 of the image capturing component 180 of the mobile device 150).

The light pattern interpreter component 195 of the mobile device 150 may interpret the captured light pattern in accordance with a pre-defined light pattern scheme to determine the information being communicated by the light pattern. The pre-defined light pattern scheme may be the conventional/legacy light pattern scheme or the new light pattern scheme described above. For example, if the electronic device 100 emits light patterns according to the conventional/legacy light pattern scheme, then the light pattern interpreter component 195 may interpret the light pattern in accordance with the conventional/legacy light pattern scheme. However, if the electronic device 100 emits light patterns according to the new light pattern scheme, then the light pattern interpreter component 195 may interpret the light pattern in accordance with the new light pattern scheme. In one embodiment, the mobile device 150 is a smartphone or other general-purpose mobile device and the light pattern interpreter component 195 is implemented as a mobile application (i.e., an “app”) that can be downloaded and executed by the mobile device 150. In one embodiment, the mobile device 150 is a special-purpose mobile device that is specifically designed for capturing and interpreting light patterns and the light pattern interpreter component 195 is implemented using special-purpose hardware (e.g., circuitry), software, and/or firmware that is integrated within the mobile device 150.

The light pattern scheme used by electronic devices 100 may differ depending on the make and/or model of the electronic devices 100. For example, different electronic devices 100 may use different conventional/legacy light pattern schemes and/or use different new light pattern schemes (e.g., that use different modulation techniques, different frame formats, different number of indicator lights 110, etc.). Thus, in one embodiment, the light pattern interpreter component 195 determines the light pattern scheme being used by the electronic device 100 based on the make and/or model number of the electronic device 100, and interprets light patterns in accordance with the determined light pattern scheme. In one embodiment, the light pattern interpreter component 195 determines the make and/or model number of the electronic device 100 based on user input (e.g., the end user may enter the make and/or model number of the electronic device 100 via a user interface displayed on the display screen 160 before taking a picture/video of the electronic device). In one embodiment, the electronic device 100 includes a quick response (QR) code 140, which may indicate the make and/or model of the electronic device 100. In this example, the model number of the electronic device 100 is “ABC1234” and the pattern of the QR code 140 is arranged to indicate this model number. The light pattern interpreter component 195 may determine the make and/or model number of the electronic device 100 based on a scan of the QR code 140 (or a bar code) of the electronic device 100 (e.g., the end user may point the image capturing component 180 of the mobile device 150 towards the QR code 140 to scan it).

The mobile device 150 may convey the information communicated by the light pattern to the end user. In one embodiment, the mobile device 150 conveys the information communicated by the light pattern using the display screen 160 (e.g., as text and/or graphics displayed on the display screen 160). In one embodiment, the mobile device 150 includes a projection component (not shown) that is able to project an image/video on a surface (e.g., a wall), and the information communicated by the light pattern can be projected using the projection component. In one embodiment, the mobile device 150 conveys the information communicated by the light pattern using the speaker 170 (e.g., as text-to-speech).

A benefit of implementing the light pattern capturing and interpretation functionality within a mobile device is that most technicians already carry mobile devices with them. While embodiments have been described in which a mobile device 150 is used to capture and interpret light patterns, in some embodiments light patterns may be captured and/or interpreted by other types of devices. For example, in one embodiment, a surveillance camera that has a line of sight to the indicator lights 110 of the electronic device 100 may capture the light patterns emitted by the indicator lights 110 of the electronic device 100 and provide the captured light patterns to a server (e.g., as video sent over a communication network) that includes a light pattern interpreter component 190 to interpret the captured light patterns. The server may interpret the light patterns to determine the information communicated by the light patterns and convey this information to an end user (e.g., by displaying the information on a display screen or sending a message to an end user (e.g., via an e-mail or text message that contains the information or a link to access the information)).

The new light pattern scheme disclosed herein may provide several advantages over the conventional/legacy light pattern scheme. For example, the new light pattern scheme can be used to communicate more detailed/rich information compared to the conventional/legacy light pattern scheme. For example, the new light pattern scheme can be used to communicate textual instructions on how to resolve a problem with the electronic device (e.g., “replace the optical pluggable in port 3 to a short range 2 km pluggable 25 Gbps”), more detailed status information (e.g., “the sync has failed for x seconds in the last y weeks,” “this node has had 4 site visits in the last 6 months,” “critical traffic on port 1, do not modify in any way”), and/or a URL associated with a web page that includes further information related to the electronic device.

Another advantage of the new light pattern scheme is that it may be used to communicate information several magnitudes faster than the conventional/legacy light pattern scheme. For example, with the conventional/legacy light pattern scheme, one or more of the indicator lights 110 may be in a “flashing slowly” state (flashing at a rate of 0.5 Hertz). Thus, at least two periods are needed to be able to detect that the indicator light 110 is in the “flashing slowly” state, which requires at least four seconds. However, with the new light pattern scheme, information may be communicated much more quickly. For example, assuming that the length of each frame period is 1/30th of a second, the use of on/off keying modulation technique, and that four frame periods are needed to communicate the information (e.g., a first frame period to indicate a frame start indicator, a second frame period to communicate actual information, a third frame period to indicate another frame start indicator, and a fourth frame period to communicate additional information), the total communication time is 4/30th of a second (˜133 milliseconds), which is magnitudes faster than 4 second (by a factor of 30) in this example.

Embodiments disclosed herein may make site visits by technicians (e.g., for deploying and maintaining electronic devices) much faster, reduce the number of errors when interpreting light patterns, and/or allow for technicians that are less-trained with regard to a specific make/model of an electronic device to easily determine the information communicated by that electronic device, thereby lowering the overall cost for the network operator.

In one embodiment, the electronic device 100 alternates between emitting light patterns according to the conventional/legacy light pattern scheme and emitting light patterns according to the new light pattern scheme. For example, the electronic device may alternate between emitting light patterns according to the conventional/legacy light pattern scheme and emitting light patterns according to the new light pattern scheme every 15 seconds. This may allow a technician that has a mobile device 150 capable of interpreting light patterns using the new light pattern scheme to take advantage of the enhanced functionality/information provided by the new light pattern scheme while still allowing a technician that does not have such a mobile device 150 to be able to determine information related to the electronic device based on the conventional/legacy light pattern scheme (e.g., based on the technician observing the conventional/legacy light patterns with his/her eyes).

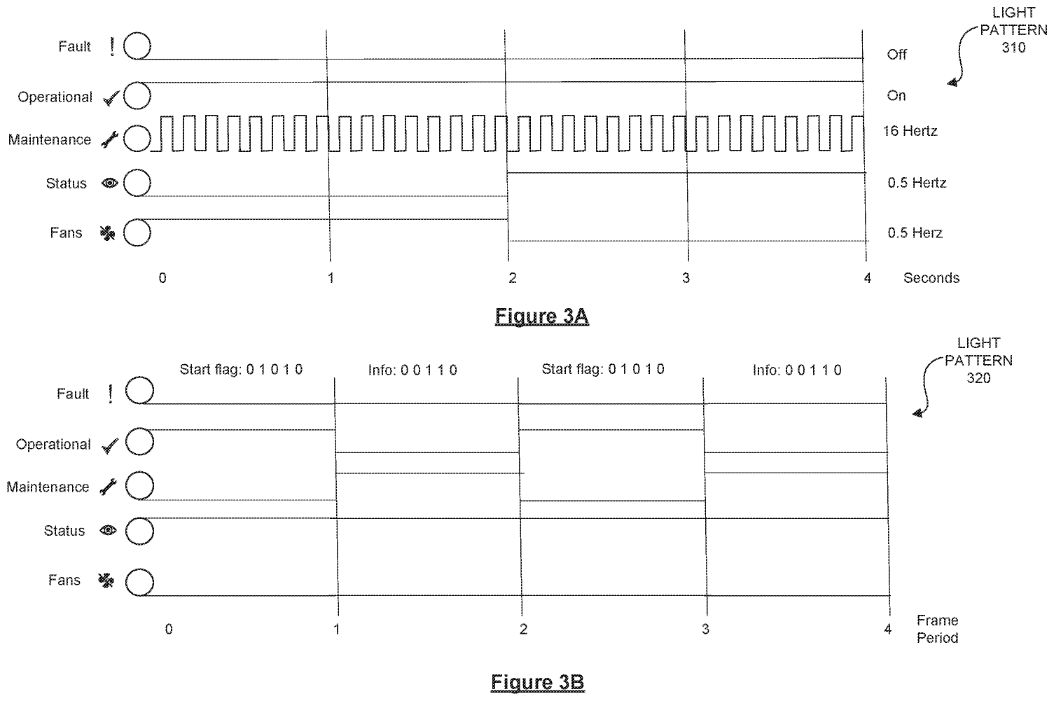

FIG. 3A is a diagram illustrating a light pattern emitted according to a conventional/legacy light pattern scheme, according to some embodiments. In the diagram, the horizontal axis represents time in seconds. In light pattern 310 the fault indicator light is in the “off” state, the operational indicator light is in the “on” state, the maintenance indicator light is in the “flickering” state (flashes at a rate of 16 Hertz), the status indicator light is in the “flashing slowly” state (flashes at a rate of 0.5 Hertz), and the fan indicator light is also in the “flashing slowly” state (flashes at a rate of 0.5 Hertz). The mobile device 150 may capture this light pattern 310 and interpret it in accordance with the light pattern scheme described by the light pattern table 200 shown in FIG. 2. For example, the mobile device 150 may determine, based on detecting that the fault indicator light is in the “off” state, that there is no fault. The mobile device 150 may further determine, based on detecting that the operational indicator light is in the “on” state, that one or more external or internal faults have been detected in the node. The mobile device 150 may further determine, based on detecting that the maintenance indicator light is in a “flickering” state (flashing at a rate of 16 Hertz), that alarms are suppressed. The mobile device 150 may further determine, based on detecting that the status light is in a “flashing slowly” state (flashing at a rate of 0.5 Hertz), that one or more faults have been detected in the remote unit. The mobile device 150 may further determine, based on detecting that the fan indicator light is in a “flashing slowly” state (flashing at a rate of 0.5 Hertz), that a fan group has been disconnected. The mobile device 150 may convey this information to an end user, for example, via the display screen 160 of the mobile device 150.

FIG. 3B is a diagram illustrating a light pattern emitted according to the new light pattern scheme, according to some embodiments. In the diagram the horizontal axis represents frame periods. In this example, light pattern 320 uses an on/off keying modulation technique. Each indicator light may be used to represent a binary value. For example, an indicator light that is in the “off” state may indicate a binary value of ‘0’ and an indicator light that is in an “on” state may indicate a binary value of ‘1.’ In the first frame period, the fault indicator light is in the “off” state (representing binary value ‘0’), the operational indicator light is in the “on” state (representing binary value ‘1’), the maintenance indicator light is in the “off” state (representing binary value ‘0’), the status indicator light is in the “on” state (representing binary value ‘1’), and the fans indicator light is in the “off” state (representing binary value ‘0’). In this frame period the indicator lights collectively represent the binary value “01010,” which may indicate a start flag.

In the second frame period, the fault indicator light is in the “off” state (representing binary value ‘0’), the operational indicator light is in the “off” state (representing binary value ‘0’), the maintenance indicator light is in the “on” state (representing binary value ‘1’), the status indicator light is in the “on” state (representing binary value ‘1’), and the fans indicator light is in the “off” state (representing binary value ‘0’). In this frame period the indicator lights collectively represent the binary value “00110,” which may indicate information related to the electronic device 100 (e.g., textual information encoded using an ASCII text encoding format).

In the third frame period, the fault indicator light is in the “off” state (representing binary value ‘0’), the operational indicator light is in the “on” state (representing binary value ‘1’), the maintenance indicator light is in the “off” state (representing binary value ‘0’), the status indicator light is in the “on” state (representing binary value ‘1’), and the fans indicator light is in the “off” state (representing binary value ‘0’). In this frame period the indicator lights collectively represent the binary value “01010,” which may indicate another start flag.

In the fourth frame period, the fault indicator light is in the “off” state (representing binary value ‘0’), the operational indicator light is in the “off” state (representing binary value ‘0’), the maintenance indicator light is in the “on” state (representing binary value ‘1’), the status indicator light is in the “on” state (representing binary value ‘1’), and the fans indicator light is in the “off” state (representing binary value ‘0’). In this frame period the indicator lights collectively represent the binary value “00110,” which may indicate further information related to the electronic device 100 (e.g., textual information encoded using an ASCII text encoding format).

It should be noted that light pattern 320 may communicate information at a much faster rate compared to light pattern 310 since each frame period may be much shorter than one second (e.g., each frame period may be 1/30th of a second). In general, the communication rate of the new light pattern scheme depends on the number of indicator lights 110 being used for emitting light patterns, the frame period length (e.g., which depends on the frame rate of the image capturing component 180), the modulation technique used, and the asynchronous nature of the video capturing to the symbol transmission phase of the indicator lights 110. While the diagram shows light pattern 320 being emitted using five indicator lights (e.g., indicator lights 110K-O), in some embodiments, light pattern 320 can be emitted using more indicator lights 110 to further increase the communication rate. For example, one or more of the indicator lights 110A-J, which are conventionally used for indicating the statuses of the respective communication ports 120A-J may also be used (in addition to using indicator lights 110K-O) to emit light patterns to further increase the communication rate.

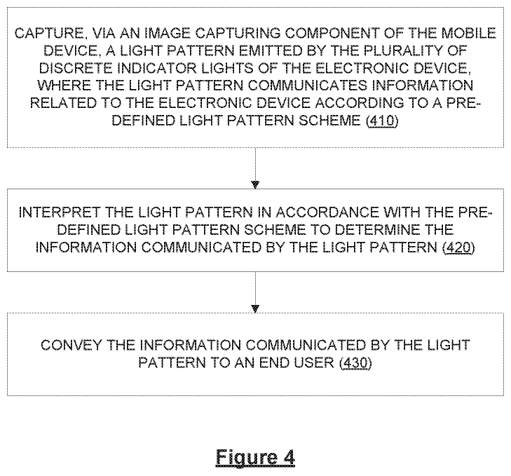

FIG. 4 is a flow diagram of a process for conveying information communicated via a plurality of indicator lights of an electronic device, according to some embodiments. The process can be implemented using hardware, software, firmware, or any combination thereof. In one embodiment, the process is implemented by a mobile device 150. The operations in the flow diagrams will be described with reference to the exemplary embodiments of the other figures. However, it should be understood that the operations of the flow diagrams can be performed by embodiments of the invention other than those discussed with reference to the other figures, and the embodiments of the invention discussed with reference to these other figures can perform operations different than those discussed with reference to the flow diagrams.

At block 410, the mobile device captures, via an image capturing component of the mobile device, a light pattern emitted by the plurality of discrete indicator lights of the electronic device, where the light pattern communicates information related to the electronic device according to a pre-defined light pattern scheme. In one embodiment, the light pattern is a static light pattern that is captured by a single image (e.g., if there is no flashing indicator lights involved). In one embodiment, the light pattern is a dynamic light pattern that is captured by a video (e.g., if there is flashing indicator lights involved). In one embodiment, the pre-defined light pattern scheme maps different pre-defined light patterns to different pre-defined information (e.g., the conventional/legacy light pattern scheme described by the light pattern table 200). In one embodiment, the pre-defined light pattern scheme uses any one of: an on/off keying modulation technique, a pulse amplitude modulation technique, and a pulse position modulation technique (e.g., the new light pattern scheme described herein). In one embodiment, the light pattern further indicates one or more of: a start of a frame, an end of a frame, a length of a frame, and error detection information. In one embodiment, the information communicated by the light pattern includes textual information encoded using an ASCII text encoding format. In one embodiment, the information communicated by the light pattern includes one or more of: information related to a status of the electronic device, information related to instructions for resolving a problem with the electronic device, and information related to a URL associated with a web page that includes information related to the electronic device. In one embodiment, the plurality of discrete indicator lights includes a plurality of monochromatic LEDs. In one embodiment, the plurality of discrete indicator lights includes one or more multichromatic LEDs. In one embodiment, the electronic device is a network device that includes a plurality of communication ports, where the plurality of discrete indicator lights includes one or more indicator lights that are each used to indicate a status of one of the plurality of communication ports of the networking device (e.g., when not being used to communicate textual information).

In one embodiment, the mobile device determines a model number of the electronic device (e.g., based on receiving an input from an end user or based on scanning the barcode or QR code of the electronic device) and determines that the light pattern is to be interpreted in accordance with the pre-defined light pattern scheme as opposed to one or more other pre-defined light pattern schemes based on the model number of the electronic device.

At block 420, the mobile device interprets the light pattern in accordance with the pre-defined light pattern scheme to determine the information communicated by the light pattern.

At block 430, the mobile device conveys the information communicated by the light pattern to an end user. In one embodiment, the information communicated by the light pattern is conveyed to the end user using a display of the mobile device (e.g., using a display screen of the mobile device or using a projection component of the mobile device). Additionally or alternatively, in one embodiment, the information communicated by the light pattern is conveyed to the end user using a speaker of the mobile device.

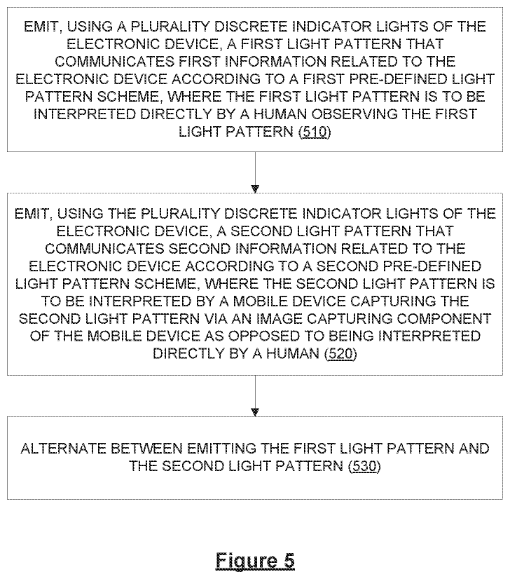

FIG. 5 is a flow diagram of a process for communicating information using a plurality of discrete indicator lights, according to some embodiments. The process can be implemented using hardware, software, firmware, or any combination thereof. In one embodiment, the process is implemented by an electronic device 100.

At block 510, the electronic device emits, using a plurality discrete indicator lights of the electronic device, a first light pattern that communicates first information related to the electronic device according to a first pre-defined light pattern scheme, where the first light pattern is to be interpreted directly by a human observing the first light pattern (e.g., the first light pattern is emitted according to the conventional/legacy light pattern scheme). In one embodiment, the plurality of discrete indicator lights includes a plurality of monochromatic LEDs. In one embodiment, the plurality of discrete indicator lights includes one or more multichromatic light emitting diodes LEDs.

At block 520, the electronic device emits, using the plurality discrete indicator lights of the electronic device, a second light pattern that communicates second information related to the electronic device according to a second pre-defined light pattern scheme, where the second light pattern is to be interpreted by a mobile device capturing the second light pattern via an image capturing component of the mobile device as opposed to being interpreted directly by a human (e.g., the second light pattern is emitted according to the new light pattern scheme). In one embodiment, the second pre-defined light pattern scheme uses one or more of: an on/off keying modulation technique, a pulse amplitude modulation technique, and a pulse position modulation technique. In one embodiment, the second information communicated by the second light pattern includes textual information is encoded using an ASCII text encoding format. In one embodiment, the second light pattern indicates one or more of: a start of a frame, an end of a frame, a length of a frame, and error detection information. In one embodiment, the electronic device is a network device that includes a plurality of communication ports, where the plurality of discrete indicator lights includes one or more indicator lights that are each used to indicate a status of one of the plurality of communication ports of the networking device (e.g., when not being used to communicate textual information).

At block 530, the electronic device alternates between emitting the first light pattern and the second light pattern (e.g., alternate every 15 seconds).

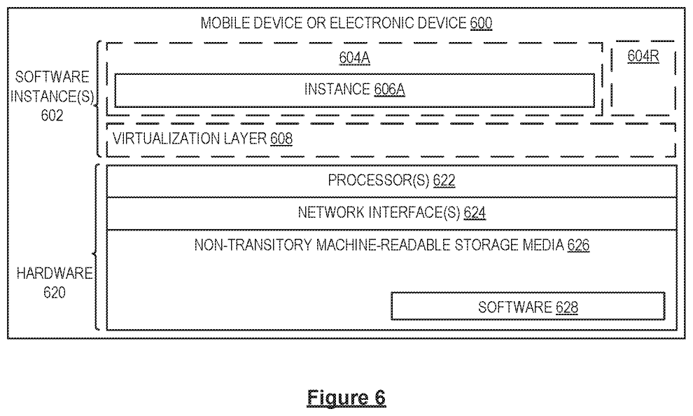

FIG. 6 is a block diagram illustrating a mobile device or electronic device, according to some embodiments. FIG. 6 illustrates hardware 620 comprising a set of one or more processor(s) 622, a set of one or more network interfaces 624 (wireless and/or wired), and non-transitory machine-readable storage medium/media 626 having stored therein software 628 (which includes instructions executable by the set of one or more processor(s) 622). Software 628 can include code, which when executed by hardware 620, causes the mobile/electronic device 600 to perform operations of one or more embodiments described herein (e.g., operations for communicating information related to the electronic device 600 via indicator lights of the electronic device 600 if the device 600 is an electronic device 100 or operations for conveying information communicated via a plurality of discrete indicator lights of an electronic device if the device 600 is a mobile device 150).

In electronic devices that use compute virtualization, the set of one or more processor(s) 622 typically execute software to instantiate a virtualization layer 608 and software container(s) 604A-R (e.g., with operating system-level virtualization, the virtualization layer 608 represents the kernel of an operating system (or a shim executing on a base operating system) that allows for the creation of multiple software containers 604A-R (representing separate user space instances and also called virtualization engines, virtual private servers, or jails) that may each be used to execute a set of one or more applications; with full virtualization, the virtualization layer 608 includes a hypervisor (sometimes referred to as a virtual machine monitor (VMM)) or a hypervisor executing on top of a host operating system, and the software containers 604A-R each represent a tightly isolated form of a software container called a virtual machine that is run by the hypervisor and may include a guest operating system; with para-virtualization, an operating system or application running with a virtual machine may be aware of the presence of virtualization for optimization purposes). Again, in electronic devices where compute virtualization is used, during operation an instance of the software 628 (illustrated as instance 606A) is executed within the software container 604A on the virtualization layer 608. In electronic devices where compute virtualization is not used, the instance 606A on top of a host operating system is executed on the “bare metal” electronic device 600. The instantiation of the instance 606A, as well as the virtualization layer 608 and software containers 604A-R if implemented, are collectively referred to as software instance(s) 602.

Alternative implementations of a mobile/electronic device may have numerous variations from that described above. For example, customized hardware and/or accelerators might also be used in a mobile/electronic device.

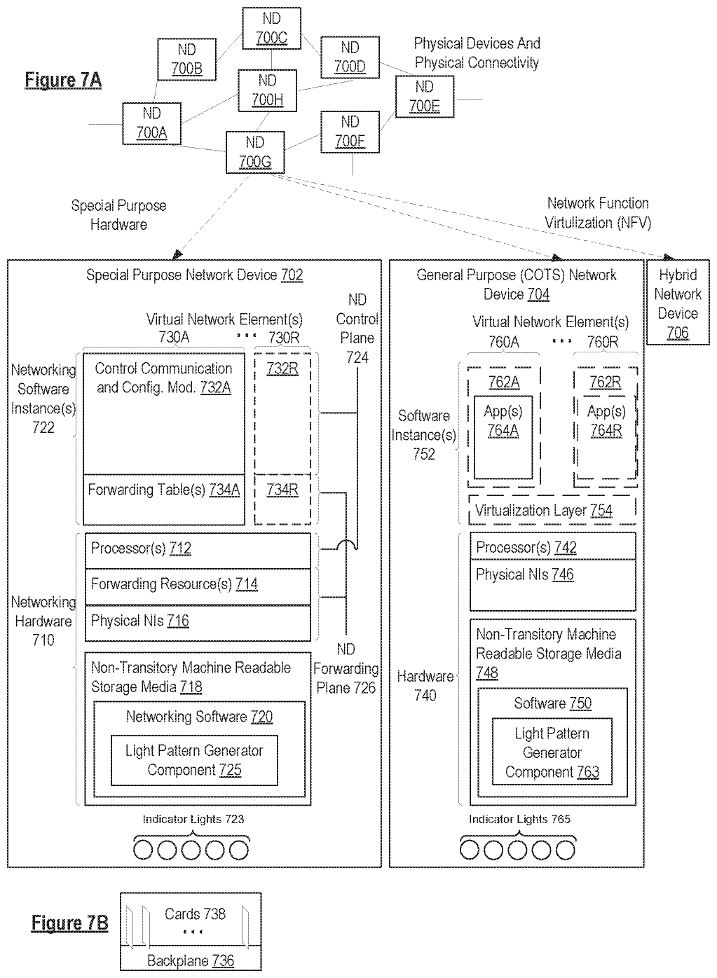

FIG. 7A illustrates connectivity between network devices (NDs) within an exemplary network, as well as three exemplary implementations of the NDs, according to some embodiments. FIG. 7A shows NDs 700A-H, and their connectivity by way of lines between 700A-700B, 700B-700C, 700C-700D, 700D-700E, 700E-700F, 700F-700G, and 700A-700G, as well as between 700H and each of 700A, 700C, 700D, and 700G. These NDs are physical devices, and the connectivity between these NDs can be wireless or wired (often referred to as a link). An additional line extending from NDs 700A, 700E, and 700F illustrates that these NDs act as ingress and egress points for the network (and thus, these NDs are sometimes referred to as edge NDs; while the other NDs may be called core NDs).

Two of the exemplary ND implementations in FIG. 7A are: 1) a special-purpose network device 702 that uses custom application-specific integrated-circuits (ASICs) and a special-purpose operating system (OS); and 2) a general purpose network device 704 that uses common off-the-shelf (COTS) processors and a standard OS.

The special-purpose network device 702 includes networking hardware 710 comprising a set of one or more processor(s) 712, forwarding resource(s) 714 (which typically include one or more ASICs and/or network processors), and physical network interfaces (NIs) 716 (through which network connections are made, such as those shown by the connectivity between NDs 700A-H), as well as non-transitory machine readable storage media 718 having stored therein networking software 720. During operation, the networking software 720 may be executed by the networking hardware 710 to instantiate a set of one or more networking software instance(s) 722. Each of the networking software instance(s) 722, and that part of the networking hardware 710 that executes that network software instance (be it hardware dedicated to that networking software instance and/or time slices of hardware temporally shared by that networking software instance with others of the networking software instance(s) 722), form a separate virtual network element 730A-R. Each of the virtual network element(s) (VNEs) 730A-R (also commonly referred to as virtual network function(s) (VNFs) or container network function(s) (CNFs)) includes a control communication and configuration module 732A-R (sometimes referred to as a local control module or control communication module) and forwarding table(s) 734A-R, such that a given virtual network element (e.g., 730A) includes the control communication and configuration module (e.g., 732A), a set of one or more forwarding table(s) (e.g., 734A), and that portion of the networking hardware 710 that executes the virtual network element (e.g., 730A).

Software 720 can include code such as light pattern generator component 725, which when executed by networking hardware 710, causes the special-purpose network device 702 to perform operations of one or more embodiments described herein above as part networking software instances 722 (e.g., to communicate information related to the special-purpose network device 702 via indicator lights 723 of the special-purpose network device 702).

The special-purpose network device 702 is often physically and/or logically considered to include: 1) a ND control plane 724 (sometimes referred to as a control plane) comprising the processor(s) 712 that execute the control communication and configuration module(s) 732A-R; and 2) a ND forwarding plane 726 (sometimes referred to as a forwarding plane, a data plane, or a media plane) comprising the forwarding resource(s) 714 that utilize the forwarding table(s) 734A-R and the physical NIs 716. By way of example, where the ND is a router (or is implementing routing functionality), the ND control plane 724 (the processor(s) 712 executing the control communication and configuration module(s) 732A-R) is typically responsible for participating in controlling how data (e.g., packets) is to be routed (e.g., the next hop for the data and the outgoing physical NI for that data) and storing that routing information in the forwarding table(s) 734A-R, and the ND forwarding plane 726 is responsible for receiving that data on the physical NIs 716 and forwarding that data out the appropriate ones of the physical NIs 716 based on the forwarding table(s) 734A-R.

FIG. 7B illustrates an exemplary way to implement the special-purpose network device 702 according to some embodiments. FIG. 7B shows a special-purpose network device including cards 738 (typically hot pluggable). While in some embodiments the cards 738 are of two types (one or more that operate as the ND forwarding plane 726 (sometimes called line cards), and one or more that operate to implement the ND control plane 724 (sometimes called control cards)), alternative embodiments may combine functionality onto a single card and/or include additional card types (e.g., one additional type of card is called a service card, resource card, or multi-application card). A service card can provide specialized processing (e.g., Layer 4 to Layer 7 services (e.g., firewall, Internet Protocol Security (IPsec), Secure Sockets Layer (SSL)/Transport Layer Security (TLS), Intrusion Detection System (IDS), peer-to-peer (P2P), Voice over IP (VoIP) Session Border Controller, Mobile Wireless Gateways (Gateway General Packet Radio Service (GPRS) Support Node (GGSN), Evolved Packet Core (EPC) Gateway)). By way of example, a service card may be used to terminate IPsec tunnels and execute the attendant authentication and encryption algorithms. These cards are coupled together through one or more interconnect mechanisms illustrated as backplane 736 (e.g., a first full mesh coupling the line cards and a second full mesh coupling all of the cards).

Returning to FIG. 7A, the general purpose network device 704 includes hardware 740 comprising a set of one or more processor(s) 742 (which are often COTS processors) and physical NIs 746, as well as non-transitory machine readable storage media 748 having stored therein software 750. During operation, the processor(s) 742 execute the software 750 to instantiate one or more sets of one or more applications 764A-R. While one embodiment does not implement virtualization, alternative embodiments may use different forms of virtualization. For example, in one such alternative embodiment the virtualization layer 754 represents the kernel of an operating system (or a shim executing on a base operating system) that allows for the creation of multiple instances 762A-R called software containers that may each be used to execute one (or more) of the sets of applications 764A-R; where the multiple software containers (also called virtualization engines, virtual private servers, or jails) are user spaces (typically a virtual memory space) that are separate from each other and separate from the kernel space in which the operating system is run; and where the set of applications running in a given user space, unless explicitly allowed, cannot access the memory of the other processes. In another such alternative embodiment the virtualization layer 754 includes a hypervisor (sometimes referred to as a virtual machine monitor (VMM)) or a hypervisor executing on top of a host operating system, and each of the sets of applications 764A-R is run on top of a guest operating system within an instance 762A-R called a virtual machine (which may in some cases be considered a tightly isolated form of software container) that is run on top of the hypervisor—the guest operating system and application may not know they are running on a virtual machine as opposed to running on a “bare metal” host electronic device, or through para-virtualization the operating system and/or application may be aware of the presence of virtualization for optimization purposes. In yet other alternative embodiments, one, some or all of the applications are implemented as unikernel(s), which can be generated by compiling directly with an application only a limited set of libraries (e.g., from a library operating system (LibOS) including drivers/libraries of OS services) that provide the particular OS services needed by the application. As a unikernel can be implemented to run directly on hardware 740, directly on a hypervisor (in which case the unikernel is sometimes described as running within a LibOS virtual machine), or in a software container, embodiments can be implemented fully with unikernels running directly on a hypervisor represented by virtualization layer 754, unikernels running within software containers represented by instances 762A-R, or as a combination of unikernels and the above-described techniques (e.g., unikernels and virtual machines both run directly on a hypervisor, unikernels and sets of applications that are run in different software containers).

The instantiation of the one or more sets of one or more applications 764A-R, as well as virtualization if implemented, are collectively referred to as software instance(s) 752. Each set of applications 764A-R, corresponding virtualization construct (e.g., instance 762A-R) if implemented, and that part of the hardware 740 that executes them (be it hardware dedicated to that execution and/or time slices of hardware temporally shared), forms a separate virtual network element(s) 760A-R.

The virtual network element(s) 760A-R perform similar functionality to the virtual network element(s) 730A-R—e.g., similar to the control communication and configuration module(s) 732A and forwarding table(s) 734A (this virtualization of the hardware 740 is sometimes referred to as network function virtualization (NFV)). Thus, NFV may be used to consolidate many network equipment types onto industry standard high volume server hardware, physical switches, and physical storage, which could be located in Data centers, NDs, and customer premise equipment (CPE). While embodiments of the invention are illustrated with each instance 762A-R corresponding to one VNE 760A-R, alternative embodiments may implement this correspondence at a finer level granularity (e.g., line card virtual machines virtualize line cards, control card virtual machine virtualize control cards, etc.); it should be understood that the techniques described herein with reference to a correspondence of instances 762A-R to VNEs also apply to embodiments where such a finer level of granularity and/or unikernels are used.

In certain embodiments, the virtualization layer 754 includes a virtual switch that provides similar forwarding services as a physical Ethernet switch. Specifically, this virtual switch forwards traffic between instances 762A-R and the physical NI(s) 746, as well as optionally between the instances 762A-R; in addition, this virtual switch may enforce network isolation between the VNEs 760A-R that by policy are not permitted to communicate with each other (e.g., by honoring virtual local area networks (VLANs)).

Software 750 can include code such as light pattern generator component 763, which when executed by processor(s) 742, cause the general purpose network device 704 to perform operations of one or more embodiments described herein above as part software instances 762A-R (e.g., to communicate information related to the general purpose network device 704 via indicator lights 765 of the general purpose network device 704).

The third exemplary ND implementation in FIG. 7A is a hybrid network device 706, which includes both custom ASICs/special-purpose OS and COTS processors/standard OS in a single ND or a single card within an ND. In certain embodiments of such a hybrid network device, a platform VM (i.e., a VM that that implements the functionality of the special-purpose network device 702) could provide for para-virtualization to the networking hardware present in the hybrid network device 706.

Regardless of the above exemplary implementations of an ND, when a single one of multiple VNEs implemented by an ND is being considered (e.g., only one of the VNEs is part of a given virtual network) or where only a single VNE is currently being implemented by an ND, the shortened term network element (NE) is sometimes used to refer to that VNE. Also in all of the above exemplary implementations, each of the VNEs (e.g., VNE(s) 730A-R, VNEs 760A-R, and those in the hybrid network device 706) receives data on the physical NIs (e.g., 716, 746) and forwards that data out the appropriate ones of the physical NIs (e.g., 716, 746). For example, a VNE implementing IP router functionality forwards IP packets on the basis of some of the IP header information in the IP packet; where IP header information includes source IP address, destination IP address, source port, destination port (where “source port” and “destination port” refer herein to protocol ports, as opposed to physical ports of a ND), transport protocol (e.g., user datagram protocol (UDP), Transmission Control Protocol (TCP), and differentiated services code point (DSCP) values.

Some portions of the preceding detailed descriptions have been presented in terms of algorithms and symbolic representations of transactions on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of transactions leading to a desired result. The transactions are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The algorithms and displays presented herein are not inherently related to any particular computer or other apparatus. Various general-purpose systems may be used with programs in accordance with the teachings herein, or it may prove convenient to construct more specialized apparatus to perform the required method transactions. The required structure for a variety of these systems will appear from the description above. In addition, embodiments are not described with reference to any particular programming language. It will be appreciated that a variety of programming languages may be used to implement the teachings of embodiments as described herein.

An embodiment may be an article of manufacture in which a non-transitory machine-readable storage medium (such as microelectronic memory) has stored thereon instructions (e.g., computer code) which program one or more data processing components (generically referred to here as a “processor”) to perform the operations described above. In other embodiments, some of these operations might be performed by specific hardware components that contain hardwired logic (e.g., dedicated digital filter blocks and state machines). Those operations might alternatively be performed by any combination of programmed data processing components and fixed hardwired circuit components.

Throughout the description, embodiments have been presented through flow diagrams. It will be appreciated that the order of transactions and transactions described in these flow diagrams are only intended for illustrative purposes and not intended as a limitation of the present invention. One having ordinary skill in the art would recognize that variations can be made to the flow diagrams without departing from the broader spirit and scope of the invention as set forth in the following claims.

In the foregoing specification, embodiments have been described with reference to specific exemplary embodiments thereof. It will be evident that various modifications may be made thereto without departing from the broader spirit and scope of the invention as set forth in the following claims. The specification and drawings are, accordingly, to be regarded in an illustrative sense rather than a restrictive sense.

What is claimed is:

1. A method by a mobile device for conveying information communicated via a plurality of discrete indicator lights of an electronic device, the method comprising:
capturing, via an image capturing component of the mobile device, a light pattern emitted by the plurality of discrete indicator lights of the electronic device, wherein the light pattern communicates information related to the electronic device according to a pre-defined light pattern scheme;
interpreting the light pattern in accordance with the pre-defined light pattern scheme to determine the information communicated by the light pattern; and
conveying the information communicated by the light pattern to an end user.

2. The method of claim 1, wherein the information communicated by the light pattern includes one or more of: information related to a status of the electronic device, information related to instructions for resolving a problem with the electronic device, and information related to a Uniform Resource Locator (URL) associated with a web page that includes information related to the electronic device.

3. The method of claim 1, wherein the information communicated by the light pattern is conveyed to the end user using a display of the mobile device.

4. The method of claim 1, wherein the information communicated by the light pattern is conveyed to the end user using a speaker of the mobile device.

5. The method of claim 1, wherein the light pattern is a static light pattern that is captured by a single image.

6. The method of claim 1, wherein the light pattern is a dynamic light pattern that is captured by a video.

7. The method of claim 6, wherein the light pattern indicates one or more of: a start of a frame, an end of a frame, a length of a frame, and error detection information.

8. The method of claim 6, wherein the information communicated by the light pattern includes textual information encoded using an American Standard Code for Information Interchange (ASCII) text encoding format.

9. The method of claim 6, wherein the pre-defined light pattern scheme uses any one of: an on/off keying modulation technique, a pulse amplitude modulation technique, and a pulse position modulation technique.

10. The method of claim 1, wherein the pre-defined light pattern scheme maps different pre-defined light patterns to different pre-defined information.

11. The method of claim 1, wherein the plurality of discrete indicator lights includes a plurality of monochromatic light emitting diodes (LEDs).

12. The method of claim 1, wherein the plurality of discrete indicator lights includes one or more multichromatic light emitting diodes (LEDs).

13. The method of claim 1, wherein the electronic device is a network device that includes a plurality of communication ports, and wherein the plurality of discrete indicator lights includes one or more indicator lights that are each used to indicate a status of one of the plurality of communication ports of the networking device.

14. The method of claim 1, further comprising:
determining a model number of the electronic device; and
determining that the light pattern is to be interpreted in accordance with the pre-defined light pattern scheme as opposed to one or more other pre-defined light pattern schemes based on the model number of the electronic device.

15. A set of one or more non-transitory machine-readable storage media storing instructions which, when executed by one or more processors of a mobile device, causes the mobile device to perform operations for conveying information communicated via a plurality of discrete indicator lights of an electronic device, the operations comprising:
capturing, via an image capturing component of the mobile device, a light pattern emitted by the plurality of discrete indicator lights of the electronic device, wherein the light pattern communicates information related to the electronic device according to a pre-defined light pattern scheme;
interpreting the light pattern in accordance with the pre-defined light pattern scheme to determine the information communicated by the light pattern; and
conveying the information communicated by the light pattern to an end user.

16. A mobile device configured to convey information communicated via a plurality of discrete indicator lights of an electronic device, the mobile device comprising:
one or more processors; and
a non-transitory machine-readable storage medium having instructions stored therein, which when executed by the one or more processors, causes the mobile device to:
capture, via an image capturing component of the mobile device, a light pattern emitted by the plurality of discrete indicator lights of the electronic device, wherein the light pattern communicates information related to the electronic device according to a pre-defined light pattern scheme,
interpret the light pattern in accordance with the pre-defined light pattern scheme to determine the information communicated by the light pattern, and
convey the information communicated by the light pattern to an end user.

17. A method by an electronic device to communicate information related to the electronic device, the method comprising:
emitting, using a plurality discrete indicator lights of the electronic device, a first light pattern that communicates first information related to the electronic device according to a first pre-defined light pattern scheme, wherein the first light pattern is to be interpreted directly by a human observing the first light pattern;
emitting, using the plurality discrete indicator lights of the electronic device, a second light pattern that communicates second information related to the electronic device according to a second pre-defined light pattern scheme, wherein the second light pattern is to be interpreted by a mobile device capturing the second light pattern via an image capturing component of the mobile device as opposed to being interpreted directly by a human; and
alternating between emitting the first light pattern and the second light pattern.

18. The method of claim 17, wherein the second information communicated by the second light pattern includes textual information is encoded using an American Standard Code for Information Interchange (ASCII) text encoding format.

19. The method of claim 17, wherein the second pre-defined light pattern scheme uses any one of: an on/off keying modulation technique, a pulse amplitude modulation technique, and a pulse position modulation technique.

20. The method of claim 17, wherein the second light pattern indicates one or more of: a start of a frame, an end of a frame, a length of a frame, and error detection information.

21. The method of claim 17, wherein the plurality of discrete indicator lights includes a plurality of monochromatic light emitting diodes (LEDs).

22. The method of claim 17, wherein the plurality of discrete indicator lights includes one or more multichromatic light emitting diodes (LEDs).

23. The method of claim 17, wherein the electronic device is a network device that includes a plurality of communication ports, and wherein the plurality of discrete indicator lights includes one or more indicator lights that are each used to indicate a status of one of the plurality of communication ports of the networking device.

24. A set of one or more non-transitory machine-readable storage media storing instructions which, when executed by one or more processors of an electronic device, causes the electronic device to perform operations for communicating information related to the electronic device, the operations comprising:
emitting, using a plurality discrete indicator lights of the electronic device, a first light pattern that communicates first information related to the electronic device according to a first pre-defined light pattern scheme, wherein the first light pattern is to be interpreted directly by a human observing the first light pattern;
emitting, using the plurality discrete indicator lights of the electronic device, a second light pattern that communicates second information related to the electronic device according to a second pre-defined light pattern scheme, wherein the second light pattern is to be interpreted by a mobile device capturing the second light pattern via an image capturing component of the mobile device as opposed to being interpreted directly by a human; and
alternating between emitting the first light pattern and the second light pattern.

25. An electronic device configured to communicate information related to the electronic device, the electronic device comprising:
one or more processors; and
a non-transitory machine-readable storage medium having instructions stored therein, which when executed by the one or more processors, causes the electronic device to:
emit, using a plurality discrete indicator lights of the electronic device, a first light pattern that communicates first information related to the electronic device according to a first pre-defined light pattern scheme, wherein the first light pattern is to be interpreted directly by a human observing the first light pattern,
emit, using the plurality discrete indicator lights of the electronic device, a second light pattern that communicates second information related to the electronic device according to a second pre-defined light pattern scheme, wherein the second light pattern is to be interpreted by a mobile device capturing the second light pattern via an image capturing component of the mobile device as opposed to being interpreted directly by a human, and
alternate between emitting the first light pattern and the second light pattern.
